(19) United States
(12) Patent Application Publication
(10) Pub. No.: US 2014/0118322 A1
(43) Pub. Date: May 1, 2014

(54) ORGANIC LIGHT EMITTING DISPLAY DEVICE AND DRIVING METHOD THEREOF

(71) Applicant: SAMSUNG DISPLAY CO., LTD., Yongin-si (KR)

(72) Inventors: Soon-Dong KIM, Yongin-si (KR); Yang-Hwa CHOI, Yongin-si (KR); Cheol-Min KIM, Yongin-si (KR); Hyung-Ryul KANG, Yongin-si (KR)

(73) Assignee: SAMSUNG DISPLAY CO., LTD., Yongin-si (KR)

(21) Appl. No.: 13/753,892

(22) Filed: Jan. 30, 2013

(30) Foreign Application Priority Data
Oct. 29, 2012 (KR) 10-2012-0120644

(51) Int. Cl. G09G 3/32

(52) U.S. Cl. CPC G09G 3/3291
USPC 345/212

(57) ABSTRACT

An organic light emitting display device is capable of improving uniformity between panels while improving an operation speed. The organic light emitting display device includes: a scan driver for supplying scan signals to scan lines; a data driver for supplying data signals to data lines; pixels located at crossing regions between the scan lines and the data lines, wherein the pixels are configured to control an amount of current supplied to an organic light emitting diode, according to a bias voltage; and a bias voltage supplier for supplying the bias voltage to the pixels, wherein a voltage value of the bias voltage is set to generate light having a desired luminance when the pixels emit light.

### CROSS-REFERENCE TO RELATED APPLICATION

This application claims priority to and the benefit of Korean Patent Application No. 10-2012-0120644, filed on Oct. 29, 2012, in the Korean Intellectual Property Office, the entire content of which is incorporated herein by reference.

### BACKGROUND

1. Field

An embodiment of the the present invention relates to an organic light emitting display device and a driving method thereof.

2. Description of the Related Art

In accordance with the development of information technology, the importance of a display device, which is the connection medium between a user and information, has emerged. Accordingly, the use of a flat panel display (FPD) such as a liquid crystal display device (LCD), an organic light emitting display device , a plasma display panel (PDP), and the like has increased.

Generally, the organic light emitting display device, which displays an image using organic light emitting diodes that generate light by recombination of electrons and holes, has a fast response speed and requires low power consumption to operate.

The organic light emitting display device includes a plurality of pixels arranged in a matrix structure at crossing regions of a plurality of data lines, scan lines, and power supply lines. Each of the plurality pixels is generally made of the organic light emitting diode, at least two transistors including a driving transistor, and lat least one capacitor.

Generally, an issue arises with organice light emitting display devices in that an amount of current flowing to the organic light emitting diodefluctuates according to a threshold voltage variation of the driving transistor included in each of the pixels. Consequentially, the pixels of the organic light emitting display device may not be displayed uniformly.

The driving transistor provided in each of the pixels may have varying characteristics depending on manufacturing process variables. Generally, it is impossible to manufacture organic light emitting display devices so that all of the transistors have the same characteristics using currently available technology.

As an example, the driving transistors may have a threshold voltage variation of approximately 3V between the panels, depending on the process variation. In this case, a data signal swing of the approximately 3V is increased according to the threshold voltage variation of the driving transistors such that a large amount of power is consumed and operation speed is deteriorated.

In addition, a larger threshold voltage variation of the driving transistor may be generated between the panels. In other words, a driving transistor disposed in a first panel and a driving transistor disposed in a second panel may have high threshold voltage variation. Accordingly, even though same data signals are supplied, the first panel and the second panel may generate light having different luminances from each other.

### SUMMARY

An aspect of the present invention is to provide an organic light emitting display device capable of reducing or minimizing power supply consumption while improving an operation speed, and a driving method thereof.

Another aspect of the present invention is to provide an organic light emitting display device capable of improving uniformity between panels, and a driving method thereof.

According to an aspect of embodiments of the present invention, an organic light emitting display device may include: a scan driver for supplying scan signals to scan lines; a data driver for supplying data signals to data lines; pixels located at crossing regions between the scan lines and the data lines, wherein the pixels are configured to control an amount of current supplied to an organic light emitting diode, according to a bias voltage; and a bias voltage supplier for supplying the bias voltage to the pixels, wherein a voltage value of the bias voltage may be set to generate light having a desired luminance when the pixels emit light.

The pixels may emit or may not emit the light according to the data signals. Each of the pixels may include a first transistor coupled between a first power supply and the organic light emitting diode, and configured to receive the bias voltage at a gate electrode thereof; a second transistor coupled between the first transistor and the organic light emitting diode and having a gate electrode coupled to a first node; a third transistor coupled between a corresponding one of the data lines and the first node and having a gate electrode coupled to a corresponding one of the scan lines; and a storage capacitor coupled between the first node and the first power supply. The first transistor may be driven in a saturation region according to the bias voltage. The second transistor may be driven in a linear region so as to be turned on or turned off according to a corresponding one of the data signals.

The bias voltage supplier may include a voltage generator for generating the bias voltage; a lookup table including information of at least one of voltage information of the scan signals, voltage information of the data signals, interval information between the scan signals and the data signals, and/or interval information between the scan signals, wherein the information corresponds to different voltage values of the bias voltage; and a controller for extracting the information corresponding to the voltage values of the bias voltage from the lookup table. The organic light emitting display device may further include a power supplier for supplying a gate-on voltage and a gate-off voltage to the scan driver so that the scan signals are generated. The power supplier may control voltage values of the gate-on voltage and the gate-off voltage so as to be proportional to the voltage value of the bias voltage, according to the information supplied from the controller.

The organic light emitting display device may further include a gamma voltage generator for supplying a gamma voltage of a first data signal, corresponding to a light-emitting state of the pixel and a gamma voltage of a second data signal corresponding to a non-light-emitting state of the pixel to the data driver. The gamma voltage generator is configured to control the voltage values of the gamma voltage of the first data signal and the gamma voltage of the second data signal so as to be proportional to the voltage value of the bias voltage, according to the information supplied from the controller. The organic light emitting display device may further include a timing controller for controlling the scan driver and the data driver. The timing controller may be configured to control a time from after the scan signals are supplied until the data signals are supplied, wherein the time is inversely proportional to the voltage value of the bias voltage, according to the information supplied from the controller. The timing controller may be configured to control an interval between the scan signals so as to be inversely proportional to the voltage value of the bias voltage, according to the information supplied from the controller. The bias voltage supplier may be configured to supply a red bias voltage to red pixels, a green bias voltage to green pixels, and a blue bias voltage to blue pixels.

According to another exemplary embodiment of the present invention, there is provided a driving method of an organic light emitting display device including: controlling an amount of current flowing to pixels according to a bias voltage; and implementing a desired gray level while controlling a light-emitting time of the pixels during one frame period, wherein a voltage value of the bias voltage is set to generate light having a desired luminance (e.g., predetermined luminance) when the pixels emit light.

The driving method may further include controlling a voltage of a scan signal according to the voltage value of the bias voltage. A gate-on voltage and a gate-off voltage of the scan signal are proportional to the voltage value of the bias voltage. The driving method may further include controlling a voltage of the data signal according to the voltage value of the bias voltage. A voltage value of a first data signal at which the pixels emit light and a voltage value of a second data signal at which the pixels do not emit light are proportional to the voltage value of the bias voltage. The driving method may further include controlling a first time from after a scan signal is supplied until a data signal is supplied, according to the voltage value of the bias voltage. The first time may be inversely proportional to the voltage value of the bias voltage. The driving method may further include controlling a second time from after the scan signal is supplied until the data signal is supplied, according to the voltage value of the bias voltage. The second time may be inversely proportional to the voltage value of the bias voltage.

As set forth above, with the organic light emitting display device and the driving method thereof, a bias voltage may be set so that the light having a desired luminance (e.g., predetermined luminance) is generated, thereby making it possible to secure a luminance uniformity between the panels. In addition, at least one of the voltages of the data signals, the voltage of the scan signal, the interval of the scan signal, and/or the interval of the scan signal and the data signal may be controlled according to the voltage value of the bias voltage, that is, the threshold voltage variation of the transistor in each panel, thereby making it possible to reduce the power consumption while improving the operation speed.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a view showing an organic light emitting display device according to an exemplary embodiment of the present invention;

FIG. 2 is a view showing one frame according to an exemplary embodiment of the present invention;

FIG. 3 is a view showing a pixel according to an exemplary embodiment of the present invention;

FIG. 4 is a view showing a bias voltage supplying unit according to an exemplary embodiment of the present invention; and

FIG. 5 is a view showing a bias voltage supplying unit according to another exemplary embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element, or may alternatively be indirectly coupled to the second element via a third element. Further, some of the elements that are not essential to the complete understanding of the invention are omitted for clarity. Also, like reference numerals refer to like elements throughout.

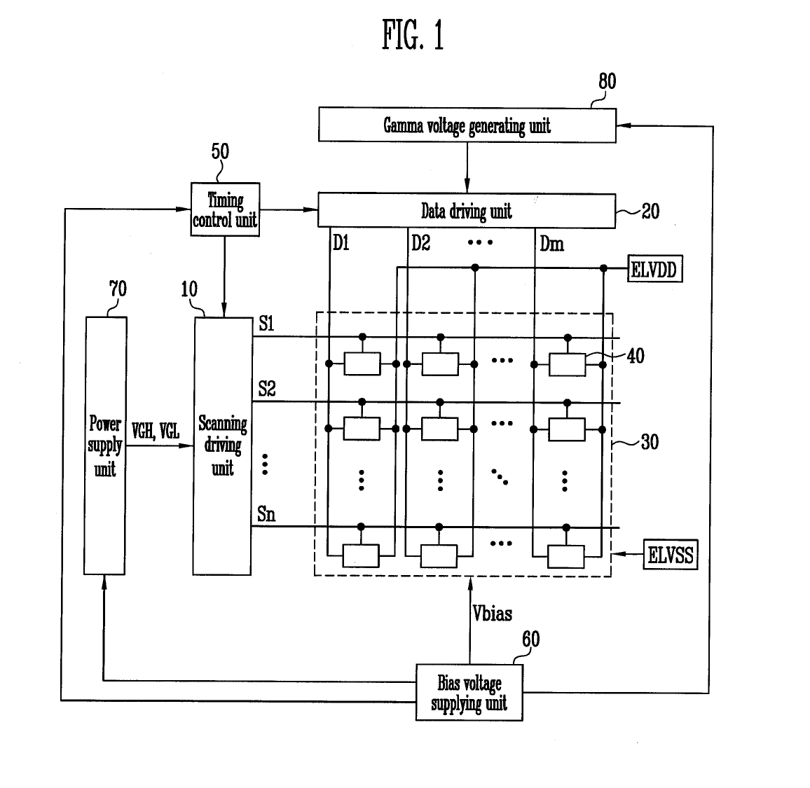

Hereinafter, exemplary embodiments of the present invention that may be practiced by those skilled in the art to which the present invention pertains will be described in detail with reference to FIGS. 1 to 5.

FIG. 1 is a view showing an organic light emitting display device according to an exemplary embodiment of the present invention.

Referring to FIG. 1, the organic light emitting display device according to an exemplary embodiment of the present invention may be configured to include a display unit 30 including a plurality of pixels 40 connected to scan lines S1 to Sn and data lines D1 to Dm, a scan driving unit (or scan driver) 10 for driving the scan lines S1 to Sn, a data driving unit (or data driver) 20 for driving the data lines D1 to Dm, and a timing control unit (or time controller) 50 for controlling the scan driving unit 10 and the data driving unit 20. In addition, the organic light emitting display device according to the exemplary embodiment of the present invention may be configured to further include a bias voltage supplying unit (or bias voltage supplier) 60 for supplying a bias voltage Vbias to the pixels 40, a gamma voltage generating unit (or gamma voltage generator) 80 for controlling the voltage of the data signals according to the bias voltage Vbias, and a power supply unit (or power supplier) 70 for controlling the voltage of the scan signals corresponding to the bias voltage Vbias.

The pixels 40 receive a first power supply ELVDD and a second power supply ELVSS supplied from the outside thereto. The pixels 40 receiving the first power supply ELVDD and the second power supply ELVSS are set to be in a light emitting or a non-light emitting state, according to the data signal.

When the pixels 40 are set to be in the light emitting state, a current supplied to an organic light emitting diode is determined by the bias voltage Vbias. As an example, the bias voltage Vbias may be set so that the current corresponding to a desired luminance (e.g., a predetermined luminance) may be supplied to the organic light emitting diode. When the bias voltage Vbias is set so that the light having the desired luminance (e.g., the predetermined luminance) is generated for each of the panels, a light having a uniform luminance may be generated for each of the panels.

When the bias voltage Vbias is set so that the light having the desired luminance is generated, a voltage value of the bias voltage Vbias may be set to be different for each of the panels, according to a threshold voltage variation. The voltage value of the bias voltage Vbias may be set in advance before shipping the panel so that an image having uniform luminance may be displayed between the panels. A detailed description with reference to the bias voltage Vbias will be described below in connection with a structure of the pixels 40.

The scan driving unit 10 supplies the scan signals to the scan lines S1 to Sn every scan period of a plurality of sub frames included in one frame. When the scan signals to the scan lines S1 to Sn are supplied, the pixels 40 are selected in horizontal line units (e.g., row-by-row).

The scan driving unit 10 generates the scan signal using a gate-off voltage VGH and a gate-on voltage VGL supplied from the power supply unit 70. As an example, when the scan signal is not supplied to the scan line S, the scan driving unit 10 may supply the gate-off voltage VGH, and when the scan signal is supplied to the scan line S, the scan driving unit 10 may supply the gate-on voltage VGL.

The data driving unit 20 supplies the data signals to the data lines D1 to Dm in synchronization with the scan signals. The data driving unit 20 supplies a first data signal to each of the data lines D1 to Dm to allow the pixels 40 to emit light, and a second data signal to each of the data lines D1 to Dm to control the pixels 40 to not emit light. The pixels 40 receiving the first data signal during the scan period are set to be in the light emitting state during the light emitting period after the scan period.

The data driving unit 20 generates the data signals using a gamma voltage supplied from the gamma voltage generating unit 80. In other words, the data driving unit 20 receives a voltage corresponding to the first data signal and a voltage corresponding to the second data signal from the gamma voltage generating unit 80. The gamma voltage generating unit 80 according to an exemplary embodiment of the present invention may be included in the data driving unit 20.

The timing control unit 50 controls the scan driving unit 10 and the data driving unit 20 corresponding to sync signals (not shown) supplied from the outside to the timing control unit 50.

The bias voltage supplying unit 60 supplies the bias voltage Vbias for each of the pixels 40. In example embodiments, the bias voltage Vbias has been experimentally determined so that the light having a desired luminance (e.g., predetermined luminance) is generated when the pixels 40 emit light. By way of example, the bias voltage may have been determined such that when white gray level (e.g., the highest gray level) is displayed, a desired luminance (e.g., predetermined luminance) is generated. In this case, the bias voltage Vbias may be set to be different for each of the panels according to the threshold voltage variation.

The power supply unit 70 generates the gate-off voltage VGH and gate-on voltage VGL, and supplies the generated gate-off voltage VGH and gate-on voltage VGL to the scan driving unit 10. The voltage values of the gate-off voltage VGH and gate-on voltage VGL is set according to the bias voltage Vbias.

The voltage value of the bias voltage Vbias may be set so that the luminance (e.g., predetermined luminance) may be implemented in the panel (that is, the display unit 30) to thereby include threshold voltage information (for example, average threshold voltage information) of the transistors formed in the panel. The power supply unit 70 generates the gate-off voltage VGH and the gate-on voltage VGL so that the transistors may be stably turned on and off in accordance with the bias voltage Vbias, that is, the threshold voltage information. Hence, the gate-off voltage VGH and gate-on voltage VGL are set in accordance with the threshold voltage information. Therefore, a voltage margin may be reduced or minimized, thereby making it possible to reduce the power supply consumption while improving operation speed.

The gamma voltage generating unit 80 supplies a gamma voltage corresponding to the first data signal and a gamma voltage corresponding to the second data signal to the data driving unit 20, according to the bias voltage Vbias. Here, since the bias voltage Vbias includes the threshold voltage information of the transistors, the gamma voltages are set according to the threshold voltage information of the transistors. In this case, the voltage margin of the data signal may be reduced or minimized, thereby making it possible to reduce the power supply consumption while improving operation speed.

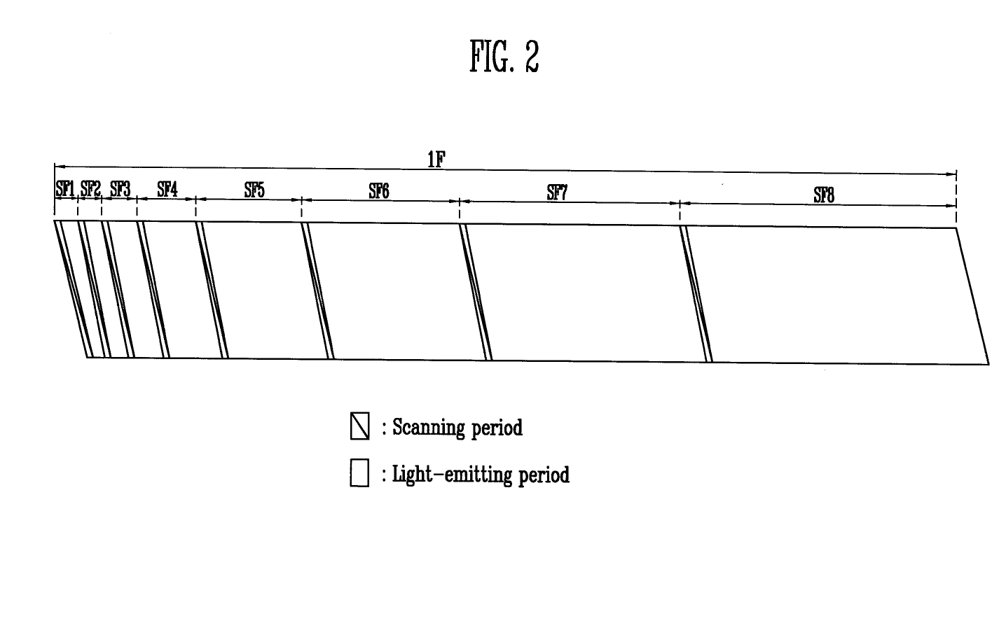

FIG. 2 is a view showing one frame according to an exemplary embodiment of the present invention.

Referring to FIG. 2, the one frame 1F period according to an exemplary embodiment of the present invention is divided into a plurality of sub frames SF1 to SF8. Each sub frame SF1 to SF8 is divided into a scan period and a light emitting period. Scan signals are supplied to scan lines S1 to Sn during the scan period, while data signals synchronized with the scan signals are also supplied to data lines D1 to Dm during the scan period. Therefore, the voltage corresponding to a first data signal or a second data signal is charged in each of the pixels 40 during the scan period.

The pixels 40 receiving the first data signal during the scan period emit light during the light-emitting period. The light-emitting period is set to be the same and/or different for each of the sub frames SF1 to SF8 so that a desired gradation (e.g., predetermined gradation) may be implemented. That is, the pixels 40, according to an exemplary embodiment of the present invention, implement a desired gradation (e.g., predetermined gradation) according to a light-emitting time of the one frame period.

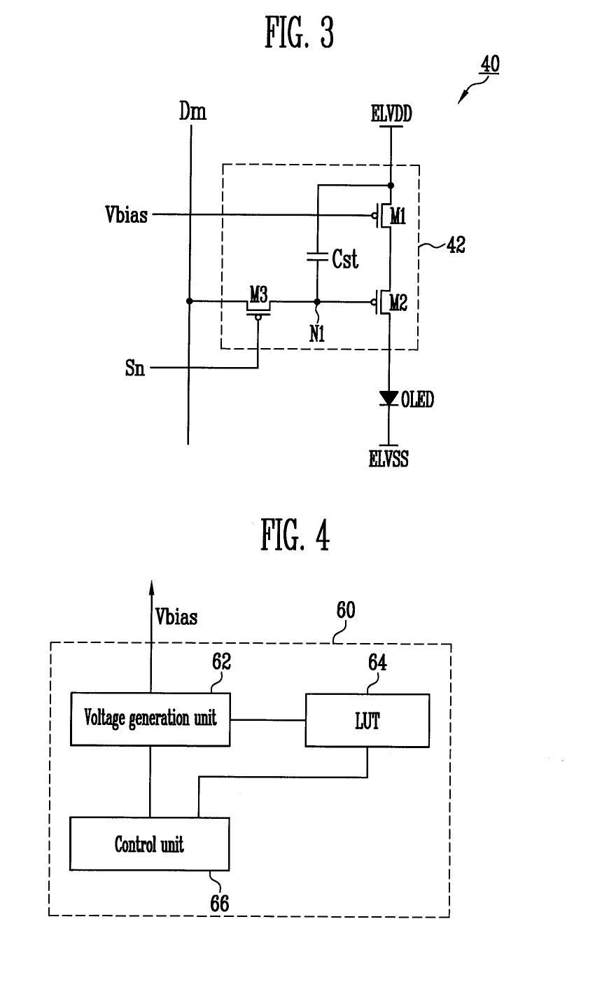

FIG. 3 is a view showing a pixel according to an exemplary embodiment of the present invention.

Referring to FIG. 3, a pixel 40 according to an exemplary embodiment of the present invention includes a pixel circuit 42 for controlling whether or not the current is supplied to the organic light emitting diode (OLED) corresponding to the data signal.

When the current is supplied from the pixel circuit 42, the organic light emitting diode (OLED) is set to be in a light emitting state, and when the current is not supplied from the pixel circuit 42, the organic light emitting diode (OLED) is set to be in a non-light emitting state.

In the pixel circuit 42, the current corresponding to the data signal is supplied to or blocked from the organic light emitting diode. To this end, the pixel circuit 42 includes a first transistor M1, a second transistor M2, a third transistor M3, and a storage capacitor Cst.

A first electrode of the first transistor M1 is connected to the first power supply ELVDD, and a second electrode of the first transistor M1 is connected to a first electrode of the second transistor M2. In addition, a gate electrode of the first transistor M1 receives a bias voltage Vbias.

Here, a voltage value of the bias voltage Vbias is set so that light having a desired luminance (e.g., predetermined luminance) may be generated in the organic light emitting diode (OLED). In other words, the bias voltage Vbias is set so that the current corresponding to the desired luminance (e.g., predetermined luminance) may be supplied to the organic light emitting diode (OLED) via the first transistor M1.

The first transistor M1 supplying the current corresponding to the luminance is driven in a saturation region according to the bias voltage Vbias.

That is, the first transistor M1, which is a current source corresponding to the bias voltage Vbias, supplies the current (e.g., predetermined current) to the organic light emitting diode (OLED) through the second transistor M2.

The first electrode of the second transistor M2 is connected to the second electrode of the first transistor M1, and the second electrode of the second transistor M2 is connected to an anode electrode of the organic light emitting diode (OLED). Further, the gate electrode of the second transistor M2 is connected to a first node N1. The second transistor M2 is turned on or off depending on the voltage of the first node N1.

That is, when the voltage corresponding to the first data signal is applied to the first node N1, the second transistor M2 is set to be in the turn-on state, and when the voltage corresponding to the second data signal is applied to the first node N1, the second transistor M2 is set to be in the turn-off state. As such, the second transistor M2 serves as a turn-on or turn-off switch and is driven in a linear region.

When the second transistor M2 is set to be in the turn-on state, the organic light emitting diode (OLED) is connected with the first transistor M1, which functions as a current source. That is, when the second transistor M2 is set to be in the turn-on state, the organic light emitting diode (OLED) is not directly connected with the voltage source (ELVDD), but is connected with the first transistor M1, which is driven as a current source. In this case, a deterioration of the organic light emitting diode (OLED) may be reduced or minimized, thereby improving the lifespan thereof.

In a digital driving according to the related art, since the organic light emitting diode (OLED) is directly connected with the voltage source, a deterioration thereof may rapidly progress. However, in an exemplary embodiment of the present invention, since the organic light emitting diode (OLED) is driven by the current supplied from the current source M1, a deterioration as compared to the related art may be slowed.

The first electrode of the third transistor M3 is connected to the data line Dm, and the second electrode thereof is connected to the first node N1. In addition, the gate electrode of the third transistor M3 is connected to the scan line Sn. When the scan signal is supplied to the scan line Sn, the third transistor M3 is turned on so that the data signal from the data line Dm is supplied to the first node N1.

The storage capacitor Cst is connected between the first power supply ELVDD and the first node N1. The storage capacitor Cst stores the voltage corresponding to the first data signal or second data signal.

Regarding the operation process of an embodiment of the present invention, first, the first transistor M1 supplies the current (e.g., predetermined current) in accordance with the bias voltage (e.g. predetermined bias voltage) Vbias so that the light having the desired luminance (e.g., predetermined luminance) may be generated.

Afterwards, the first or second data signal is supplied for each of the scan periods of the sub frames SF1 to SF8, depending on the desired gradation, such that the voltage (e.g., predetermined voltage) is stored in the storage capacitor Cst. The second transistor M2 is turned on or turned off according to the voltage stored in the storage capacitor Cst.

When the second transistor M2 is turned on, the current is supplied from the first transistor M1 to the organic light emitting diode (OLED) so that the organic light emitting diode (OLED) is set to be in the light emitting state. When the second transistor M2 is turned off, the current is not supplied to the organic light emitting diode (OLED) so that the organic light emitting diode (OLED) is set to be in the non-light emitting state.

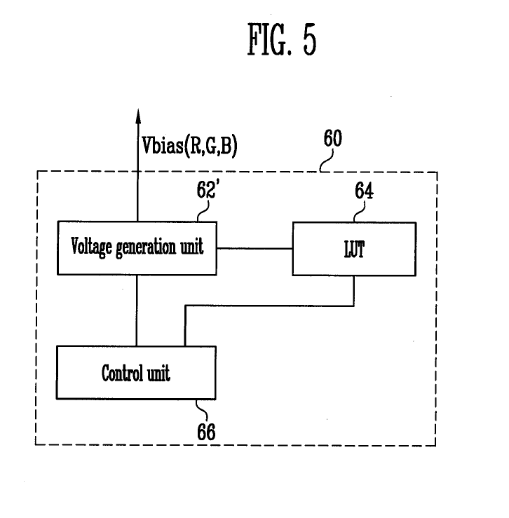

FIG. 4 is a view showing a bias voltage supplying unit according to an exemplary embodiment of the present invention.

Referring to FIG. 4, the bias voltage supplying unit 60 according to an exemplary embodiment of the present invention includes a voltage generating unit (or voltage generator) 62, a look up table 64 (LUT) and a control unit (or controller) 66.

The voltage generating unit 62 generates the bias voltage Vbias to supply the generated voltage to the pixels 40. Here, when a full white gradation is implemented to the panel, the bias voltage Vbias is preset during the inspection process and the like so that light having the desired luminance (e.g., predetermined luminance) is generated by each of the panels. In this case, the bias voltage Vbias is set to be different from each other according to an average threshold voltage variation of transistors in the panels so that light having the same luminance may be generated by each of the panels.

Information of at least one characteristic or parameter such as a gate-on voltage VGL, a gate-off voltage VGH, a first data signal gamma voltage, a second data signal gamma voltage, an interval of the scan signal and data signal, and/or an interval of the scan signal corresponding to the bias voltage Vbias may be stored in LUT 64.

For example, the information as shown in the following Table 1 may be stored in the LUT 64.

TABLE 1

| Vbias (V) | Vth (V) | VGH (V) | VGL (V) | data_H (V) | data_L (V) | T_fd (s) | T_no (s) |
|---|---|---|---|---|---|---|---|
| 4 | −1 | 9 | −11 | 7 | −3.3 | 9.0E−08 | 2.9E−07 |
| 3 | −2 | 8 | −12 | 6 | −4.4 | 1.0E−07 | 3.2E−07 |
| 2 | −3 | 7 | −13 | 5 | −5.5 | 1.1E−07 | 3.5E−07 |
| 1 | −4 | 6 | −14 | 4 | −6.6 | 1.2E−07 | 3.8E−07 |

Referring to Table 1, the average threshold voltage information of the transistors may be extracted corresponding to the bias voltage Vbias generated to the voltage generating unit 62. Actually, the bias voltage Vbias is set to have a voltage difference (e.g., predetermined voltage difference) so that the current corresponding to the desired luminance (e.g., predetermined luminance) is supplied to the organic light emitting diode. In this case, as shown in Table 1, as the bias voltage Vbias increases, the threshold voltage Vth also increases.

Because the transistors located on the same panel are formed under the same process conditions, they likely have approximately similar threshold voltages. However, because the transistors located on different panels are formed at different times from each other, they have a threshold voltage variation of about 3V.

When the bias voltage is determined and sent to the voltage generating unit 62, the gate-on voltage VGL and the gate-off voltage VGH are set according to the bias voltage Vbias. The control unit 66 extracts the gate-on voltage VGL and the gate-off voltage VGH corresponding to the bias voltage Vbias from the LUT 64 and supplies the extracted information to the power supply unit 70. As a result, the power supply unit 70 transmits to the scan driving unit 10 the gate-on voltage VGL and the gate-off voltage VGH corresponding to the information supplied from the control unit 66.

In the case of the gate-on voltage VGL and the gate-off voltage VGH, as the bias voltage Vbias increases, VGL and VGH also increase. In other words, the voltage values of the gate-on voltage VGL and the gate-off voltage VGH are directly proportional to the voltage value of the bias voltage Vbias.

When the bias voltage Vbias is determined by the voltage generating unit 62, a voltage value of a gamma voltage data_L of the first data signal and a gamma voltage data_H of the second data signal are set according to the bias voltage Vbias. The control unit 66 extracts the gamma voltage data_L of the first data signal and the gamma voltage data_H of the second data signal according to the bias voltage Vbias and supplies the extracted information to the gamma voltage generating unit 80. As a result, the gamma voltage generating unit 80 transmits the gamma voltage data_L of the first data signal and the gamma voltage data_H of the second data signal to the data driving unit 20 according to the information supplied from the control unit 66.

At this time, the gamma voltage data_L of the first data signal and the gamma voltage data_H of the second data signal are increased as bias voltage increases. Accordingly, the voltage value of the gamma voltage data_L of the first data signal and the gamma voltage data_H of the second data signal are calibrated depending on the voltage value of the bias voltage Vbias.

When the bias voltage Vbias is determined by the voltage generating unit 62, an interval T_fd of the scan signal and data signal is set according to the bias voltage Vbias. Here, the interval T_fd of the scan signal and data signal represents the time between when the scan signal is supplied and when the data signal is supplied. The control unit 66 supplies the interval T_fd information of the scan signal and data signal to the timing control unit 50 according to the bias voltage Vbias. Then, the timing control unit 50 controls the scan driving unit 10 and the data driving unit 20 to provide for the interval T_fd of the scan signal and the data signal. The interval T_fd of the scan signal and the data signal decreases as bias voltage Vbias increases (e.g., an inverse relationship).

When the bias voltage Vbias is determined by the voltage generating unit 62, an interval T_no of the scan signals is set according to the bias voltage Vbias. The interval T_no of the scan signals represents the time between when the previous scan signal was supplied and when the next scan signal will be supplied. The control unit 66 supplies the interval T_no information regarding time between the scan signals to the timing control unit 50 according to the bias voltage Vbias. As a result, the timing control unit 50 controls the scan driving unit 10 in order to control the scan signal according to the interval T_no. The interval T_no between the scan signals decreases as bias voltage Vbias increases (inverse relationship).

FIG. 5 is a view showing a bias voltage supplying unit according to another exemplary embodiment of the present invention. In describing FIG. 5, the same components as FIG. 4 are denoted by the same reference numerals and therefore the description thereof may be omitted.

Referring to FIG. 5, the voltage generation unit (or voltage generator) 62′ according to another exemplary embodiment of the present invention generates a red bias voltage Vbias R, a green bias voltage Vbias G, and a blue bias voltage Vbias B corresponding to a red pixel, a green pixel, and a blue pixel, respectively.

The red bias voltage Vbias R is supplied to the red pixels, and the voltage value thereof is set so that light having a luminance (e.g., predetermined luminance) is generated corresponding to a full white to the red pixels.

The green bias voltage Vbias G is supplied to the green pixels, and the voltage value thereof is set so that light having a luminance (e.g., predetermined luminance) is generated corresponding to a full white to the green pixels.

The blue bias voltage Vbias B is supplied to the blue pixels, and the voltage value thereof is set so that light having a luminance (e.g., predetermined luminance) is generated corresponding to the full white to the blue pixels.

That is, the bias voltage supplying unit 60 according to another exemplary embodiment of the present invention generates separate bias voltages Vbias R, G, and B corresponding to the red pixel, the green pixel, and the blue pixel, respectively. In this case, the bias voltage supplying unit 60 may set the bias voltage Vbias R, G, and B to reflect characteristics of the red pixel, the green pixel, and the blue pixel, respectively, thereby making it possible to stably implement a desired luminance. In this case, the gate-on voltage VGL, the gate-off voltage VGH, the first data signal gamma voltage, the second data signal gamma voltage, the interval between the scan signal and the data signal, and the interval information of the scan signals may be stored as corresponding to at least one of the red bias voltage Vbias R, the green bias voltage Vbias G, and/or the blue bias voltage Vbias B.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device comprising:
a scan driver for supplying scan signals to scan lines;
a data driver for supplying data signals to data lines;
pixels located at crossing regions between the scan lines and the data lines, wherein the pixels are configured to control an amount of current supplied to an organic light emitting diode, according to a bias voltage; and
a bias voltage supplier for supplying the bias voltage to the pixels,
wherein a voltage value of the bias voltage is set to generate light having a desired luminance when the pixels emit light.

2. The organic light emitting display device according to claim 1, wherein the pixels emit or do not emit the light according to the data signals.

3. The organic light emitting display device according to claim 1, wherein each of the pixels comprises:
a first transistor coupled between a first power supply and the organic light emitting diode, and configured to receive the bias voltage at a gate electrode thereof;
a second transistor coupled between the first transistor and the organic light emitting diode and having a gate electrode coupled to a first node;
a third transistor coupled between a corresponding one of the the data lines and the first node and having a gate electrode coupled to a corresponding one of the scan lines; and
a storage capacitor coupled between the first node and the first power supply.

4. The organic light emitting display device according to claim 3, wherein the first transistor is driven in a saturation region according to the bias voltage.

5. The organic light emitting display device according to claim 3, wherein the second transistor is driven in a linear region so as to be turned on or turned off according to a corresponding one of the data signals.

6. The organic light emitting display device according to claim 1, wherein the bias voltage supplier comprises:
a voltage generator for generating the bias voltage;
a lookup table comprising information of at least one of voltage information of the scan signals, voltage information of the data signals, interval information between the scan signals and the data signals, and/or interval information between the scan signals, wherein the information corresponds to different voltage values of the bias voltage; and
a controller for extracting the information corresponding to the voltage values of the bias voltage from the lookup table.

7. The organic light emitting display device according to claim 6, further comprising a power supplier for supplying a gate-on voltage and a gate-off voltage to the scan driver so that the scan signals are generated.

8. The organic light emitting display device according to claim 7, wherein the power supplier controls voltage values of the gate-on voltage and the gate-off voltage so as to be proportional to the voltage value of the bias voltage, according to the information supplied from the controller.

9. The organic light emitting display device according to claim 6, further comprising a gamma voltage generator for supplying a gamma voltage of a first data signal corresponding to a light-emitting state of the pixel and a gamma voltage of a second data signal corresponding to a non light-emitting state of the pixel to the data driver.

10. The organic light emitting display device according to claim 9, wherein the gamma voltage generator is configured to control the voltage values of the gamma voltage of the first data signal and the gamma voltage of the second data signal so as to be proportional to the voltage value of the bias voltage, according to the information supplied from the controller.

11. The organic light emitting display device according to claim 6, further comprising a timing controller for controlling the scan driver and the data driver.

12. The organic light emitting display device according to claim 11, wherein the timing controller is configured to control a time from after the scan signals are supplied until the data signals are supplied, wherein the time is inversely proportional to the voltage value of the bias voltage, according to the information supplied from the controller.

13. The organic light emitting display device according to claim 11, wherein the timing controller is configured to control an interval between the scan signals so as to be inversely proportional to the voltage value of the bias voltage, according to the information supplied from the controller.

14. The organic light emitting display device according to claim 1, wherein the bias voltage supplier is configured to supply a red bias voltage to red pixels, a green bias voltage to green pixels, and a blue bias voltage to blue pixels.

15. A driving method of an organic light emitting display device, the driving method comprising:
controlling an amount of current flowing to pixels according to a bias voltage; and
implementing a desired gray level while controlling a light-emitting time of the pixels during one frame period,
wherein a voltage value of the bias voltage is set to generate light having a desired luminance when the pixels emit light.

16. The driving method according to claim 15, further comprising controlling a voltage of a scan signal, according to the voltage value of the bias voltage.

17. The driving method according to claim 16, wherein a gate-on voltage and a gate-off voltage of the scan signal are proportional to the voltage value of the bias voltage.

18. The driving method according to claim 15, further comprising controlling a voltage of the data signal, according to the voltage value of the bias voltage.

19. The driving method according to claim 18, wherein a voltage value of a first data signal at which the pixels emit light and a voltage value of a second data signal at which the pixels do not emit light are proportional to the voltage value of the bias voltage.

20. The driving method according to claim 15, further comprising controlling a first time from after a scan signal is supplied until a data signal is supplied, according to the voltage value of the bias voltage.

21. The driving method according to claim 20, wherein the first time is inversely proportional to the voltage value of the bias voltage.

22. The driving method according to claim 21, further comprising controlling a second time from after the scan signal is supplied until the data signal is supplied, according to the voltage value of the bias voltage.

23. The driving method according to claim 22, wherein the second time inversely proportional to the voltage value of the bias voltage.
